(19) United States
(12) Patent Application Publication
(10) Pub. No.: US 2026/0173108 A1
(43) Pub. Date: Jun. 18, 2026

(54) ADAPTING RACH OCCASIONS IN A WIRELESS COMMUNICATION SYSTEM

(71) Applicant: Samsung Electronics Co., Ltd., Suwon-si (KR)

(72) Inventors: Anil Agiwal, McKinney, TX (US); Hongbo Si, Allen, TX (US); Kyeongin Jeong, Frisco, TX (US)

(21) Appl. No.: 19/414,175

(22) Filed: Dec. 9, 2025

Related U.S. Application Data
(60) Provisional application No. 63/735,681, filed on Dec. 18, 2024.
(60) Provisional application No. 63/747,642, filed on Jan. 21, 2025.

(51) Int. Cl. H04W 72/232

(52) U.S. Cl. CPC H04W 72/232

(57) ABSTRACT

A user equipment (UE) includes a transceiver configured to receive, from a base station (BS), one or more random access (RA) configurations for one or more bandwidth parts (BWPs) of a cell. Each RA configuration includes (i) a first set of random access occasions (ROs) and (ii) a second set of ROs, and is associated with at least a feature or a feature combination. The transceiver is also configured to receive, from the BS, in a paging occasion (PO), a physical downlink control channel (PDCCH) for downlink control information (DCI) addressed to a paging radio network temporary identifier (P-RNTI). The UE also includes a processor operably coupled to the transceiver. The processor is configured to determine, based on an indication in the DCI addressed to the P-RNTI, that the second set of ROs is activated.

### CROSS-REFERENCE TO RELATED APPLICATION(S) AND CLAIM OF PRIORITY

This application claims priority under 35 U.S.C. § 119(e) to U.S. Provisional Patent Application No. 63/735,681 filed on Dec. 18, 2024, and U.S. Provisional Patent Application No. 63/747,642 filed on Jan. 21, 2025. The above-identified provisional patent applications are hereby incorporated by reference in their entirety.

### TECHNICAL FIELD

This disclosure relates generally to wireless networks. More specifically, this disclosure relates to adapting random access channel (RACH) occasions in wireless communications systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for adapting RACH occasions in wireless communications systems.

In one embodiment, a user equipment (UE) is provided. The UE includes a transceiver configured to receive, from a base station (BS), one or more random access (RA) configurations for one or more bandwidth parts (BWPs) of a cell. Each RA configuration includes (i) a first set of random access occasions (ROs) and (ii) a second set of ROs, and is associated with at least a feature or a feature combination. The transceiver is also configured to receive, from the BS, in a paging occasion (PO), a physical downlink control channel (PDCCH) for downlink control information (DCI) addressed to a paging radio network temporary identifier (P-RNTI). The UE also includes a processor operably coupled to the transceiver. The processor is configured to determine, based on an indication in the DCI addressed to the P-RNTI, that the second set of ROs is activated.

In another embodiment, a BS is provided. The BS includes a processor, and a transceiver operably coupled to the processor. The transceiver is configured to transmit, to a UE, one or more RA configurations for one or more BWPs of a cell. Each RA configuration includes (i) a first set of ROs and (ii) a second set of ROs, and is associated with at least a feature or a feature combination. The transceiver is also configured to transmit, to the UE, information indicating whether the UE selects the first set of ROs or the second set of ROs for random access preamble transmission. The transceiver is further configured to transmit, to the UE, in a PO, a PDCCH for DCI addressed to a P-RNTI. The DCI addressed to the P-RNTI includes at least one of RA type, BWP info, and carrier type of random access configuration for which the second set of ROS are activated.

In yet another embodiments, a method of operating a UE is provided. The method includes receiving, from a BS, one or more RA configurations for one or more BWPs of a cell. Each RA configuration includes (i) a first set of ROs, and (ii) a second set of ROs. The method also includes receiving, from the BS, in a PO, a PDCCH for DCI addressed to a P-RNTI. The method further includes determining, based on an indication in the DCI addressed to the P-RNTI, that the second set of ROs is activated.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for activating additional ROs according to embodiments of the present disclosure;

FIG. 5 illustrates another example procedure for activating additional ROs according to embodiments of the present disclosure;

FIG. 6 illustrates another example procedure for activating additional ROs according to embodiments of the present disclosure;

FIG. 7 illustrates another example procedure for activating additional ROs according to embodiments of the present disclosure;

FIG. 8 illustrates another example procedure for activating additional ROs according to embodiments of the present disclosure;

FIG. 9 illustrates another example procedure for activating additional ROs according to embodiments of the present disclosure;

FIG. 10 illustrates another example procedure for activating additional ROs according to embodiments of the present disclosure;

FIG. 11 illustrates an example method for adapting RACH occasions according to embodiments of the present disclosure; and

FIG. 12 illustrates another example method for adapting RACH occasions according to embodiments of the present disclosure.

### DETAILED DESCRIPTION

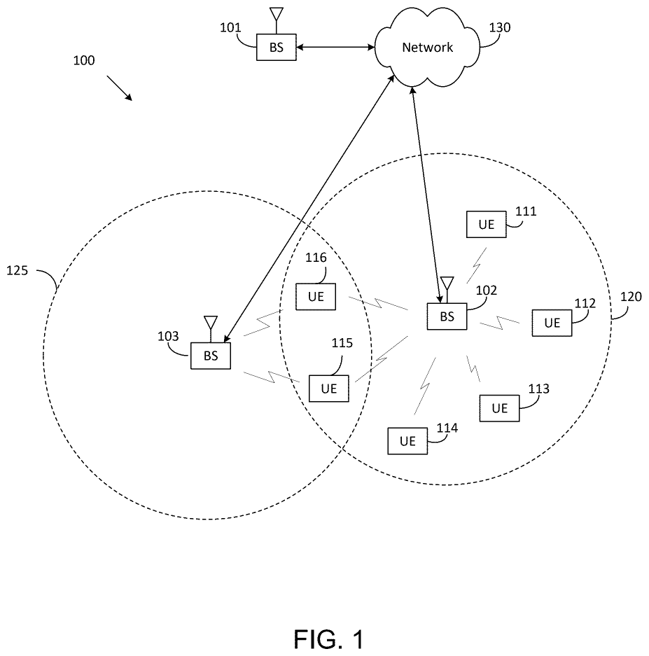

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for adapting RACH occasions. In certain embodiments, one or more of the gNBs 101-103 includes circuitry, programing, or a combination thereof, to support adapting RACH occasions in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

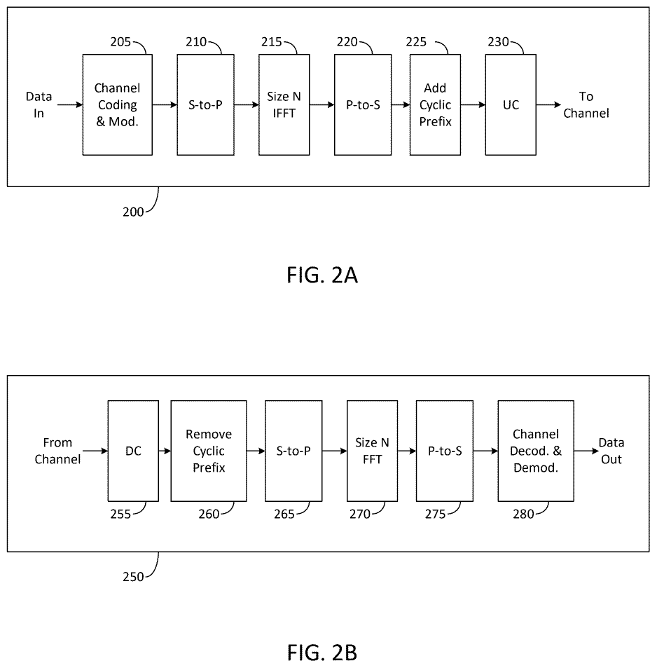

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support adapting RACH occasions as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

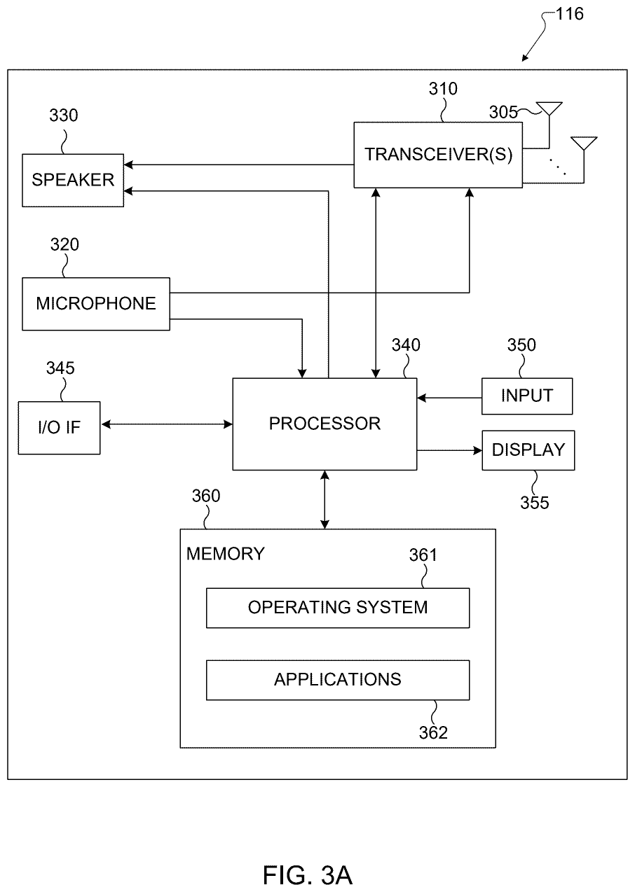

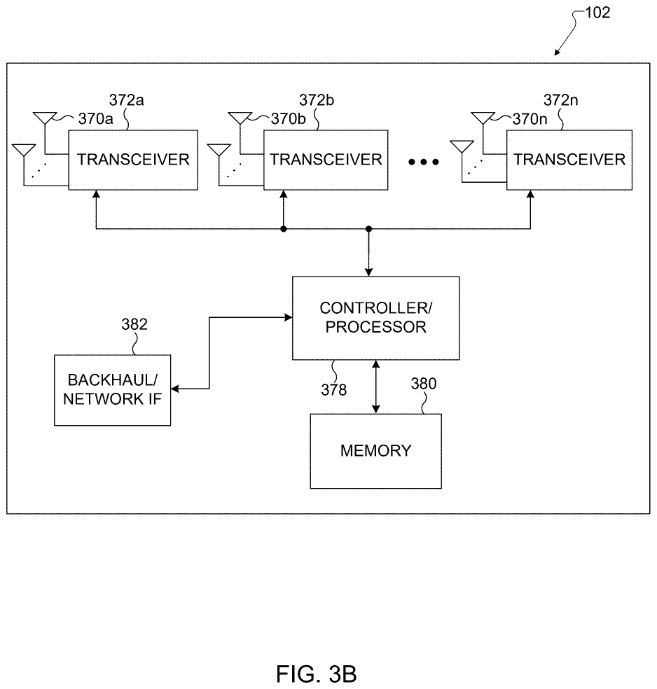

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for adapting RACH occasions as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support adapting RACH occasions as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the

### Term Spcell Refers to the Pcell.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB 1 from the cell. The SIB1 is transmitted on the downlink shared channel (DL-SCH) with a periodicity of 160 ms and variable transmission repetition. The default transmission repetition periodicity of SIB 1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot) =0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G (B5G), 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random-access procedure are supported such as contention based random access, contention free random access and each of these can be one of 2 step or 4 step random access.

In contention based random access (CBRA), also referred as 4 step CBRA, the UE first transmits a Random Access preamble (also referred to as Msg1) and then waits for a Random access response (RAR) in the RAR window. The RAR is also referred to as Msg2. A next generation node B (gNB) transmits the RAR on the physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg 1, (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for a normal UL [NUL] carrier and 1 for a supplementary UL [SUL] carrier. Several RARs for various Random-access preambles detected by the gNB can be multiplexed in the same RAR media access control (MAC) protocol data unit (PDU) by the gNB. A RAR in MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., select a random access resource [preamble/RACH occasion]) and transmits the RA preamble. A backoff may be applied before going back to first step.

If the RAR corresponding to its RA preamble transmission is received, the UE transmits a message 3 (Msg3) in the UL grant received in the RAR. The Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., select random access resource [preamble/RACH occasion]) and transmits the RA preamble. A backoff may be applied before going back to first step.

Contention free random access (CFRA), also referred to as legacy CFRA or 4 step CFRA, is used for scenarios such as handover where low latency is required, timing advance establishment for secondary cell (Scell), etc. An evolved node B (eNB) assigns to the UE a dedicated Random access preamble. The UE transmits the dedicated RA preamble. The eNB transmits the RAR on a PDSCH addressed to a RA-RNTI. The RAR conveys an RA preamble identifier and timing alignment information. The RAR may also include an UL grant. The RAR is transmitted in RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

Network energy saving is of great importance for environmental sustainability, to reduce environmental impact (greenhouse gas emissions), and for operational cost savings. As wireless communication systems are becoming pervasive across industries and geographical areas, handling more advanced services and applications requiring very high data rates (e.g., XR), networks are becoming denser, more antennas, use larger bandwidths and use more frequency bands. Novel solutions to improve network energy savings are desirable to control the environmental impact of wireless communications systems.

Energy consumption has become a key part of the operators'OPEX. The energy cost on mobile networks accounts for ˜23% of the total operator cost. Most of the energy consumption comes from the radio access network, and in particular from the Active Antenna Unit (AAU), with data centers and fiber transport accounting for a smaller share. The power consumption of a radio access can be split into two parts: the dynamic part which is only consumed when data transmission/reception is ongoing, and the static part which is consumed all the time to maintain the necessary operation of the radio access devices, even when data transmission/reception is not on-going.

Existing networks signal random access configurations per BWP. Each BWP may include one or more random access configuration, wherein each random access configuration is mapped to a feature or feature combination or not mapped to any feature. Example feature include small data transmission (SDT), reduced capability (redcap), enhanced redcap (eRedcap), slicing, Msg3 repetition, Msg1 repetition, etc.

In some embodiments, random access configurations can include one or more contention based random access preambles.

In some embodiments, random access configurations can include a parameter prach-ConfigurationIndex which indicates the available set of PRACH occasions in time domain for the transmission of the Random Access Preamble. The number of PRACH occasions in PRACH configuration period is pre-defined for each PRACH configuration index. The PRACH configuration period for each PRACH configuration index is also pre-defined. A pre-defined PRACH configuration table lists a number of configurations, wherein each configuration indicates a number of PRACH occasions in a PRACH configuration period, the PRACH configuration period, and the location of PRACH occasions in the PRACH configuration period. A PRACH configuration index is an index to an entry in this PRACH configuration table.

In some embodiments, random access configurations can include the parameters msg1-FrequencyStart and msg1-FDM which indicate the PRACH transmission occasions in the frequency domain. msg1-FrequencyStart is the offset of lowest PRACH transmission occasion in the frequency domain with respect to PRB 0. msg1-FDM indicates the number of PRACH transmission occasions frequency division multiplexed (FDMed) in one time instance.

PRACH adaptation is being considered for enhancing network energy savings. In some embodiments, for PRACH adaptation, in addition to existing PRACH transmission occasions, additional PRACH transmission occasions/resources can be configured in random access configurations. The additional PRACH transmission occasions/resources for a random access configuration can be signaled by including at least one of msg1-FrequencyStart, msg1-FDM, and/or prach-ConfigurationIndex separately for additional PRACH transmission occasions/resources. These additional PRACH transmission occasions/resources can be dynamically activated/deactivated by the network, and a UE considers them for random access if activated.

The additional PRACH transmission occasions/resources can be dynamically activated and/or deactivated by DCI transmitted in a paging occasion.

In a cell supporting paging early indication (PEI), the network will set a bit corresponding to each PEI subgroup identity to 1 in DCI transmitted in the PEI-O. After receiving the PEI (i.e., DCI in a PEI-O), the UE monitors its PO, and based on the received DCI in the PO, the UE knows whether the additional PRACH transmission occasions/resources are activated or not. In this operation the network transmits both DCI in the PEI-O and DCI in the PO resulting in more signaling overhead and wakeup time. This also increases the UE's wakeup time.

In a cell supporting low power wakeup signal (LPWUS), the network includes a common LPWUS group ID in the LPWUS occasion (LO). After receiving this, the UE monitors its PO and based on the received DCI in the PO, and the UE knows whether the additional PRACH transmission occasions/resources are activated or not. In this operation the network transmits both an LPWUS in the LO and DCI in the PO resulting in more signaling overhead and wakeup time. This also increases the UE's wakeup time.

The UE may be configured with several initial uplink BWPs (such as an initial uplink BWP on the SUL, an initial uplink BWP on the NUL, a redcap specific initial uplink BWP, and one or more non initial uplink BWPs). Each BWP has their own one or more random access configurations. Various embodiments of the present disclosure provide mechanisms for the UE to determine which random access configuration(s) additional PRACH transmission occasions/resources are activated for upon receiving the DCI.

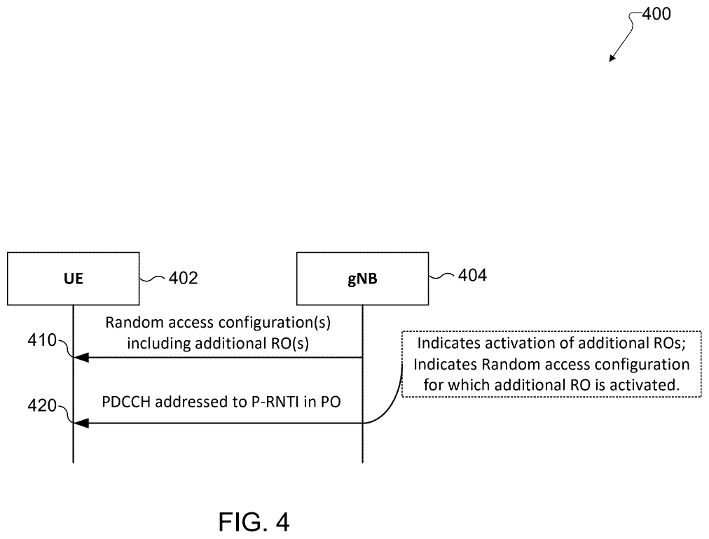

FIG. 4 illustrates an example procedure for activating additional ROs 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for activating additional ROs could be used without departing from the scope of this disclosure.

In the example of FIG. 4, at operation 410 a UE 402 receives one or more random access configurations from a gNB 404. Each random access configuration can be a 2 step random access configuration or 4 step random access configuration. These random access configurations can be received for one or more BWPs. Each random access configuration can be mapped to a feature or feature combination or not mapped to any feature. Example features include SDT, redcap, eRedcap, slicing, Msg3 repetition, Msg1, repetition etc.

Each random access configuration includes parameters (prach-ConfigurationIndex, msg1-FrequencyStart and/or msg1-FDM) to configure a first set of PRACH transmission occasions (ROs). Each random access configuration may include a second set of PRACH transmission occasions (which may also be referred to as additional PRACH transmission occasions/resources). The additional PRACH transmission occasions/resources for a random access configuration can be signaled by including at least one of msg1-FrequencyStart, msg1-FDM, and/or prach-ConfigurationIndex separately for the additional PRACH transmission occasions/resources. The additional PRACH transmission occasions/resources can be configured in one or more of these random access configurations.

ROs in each of these two sets of PRACH transmission occasions are mapped to SSBs transmitted in the cell. The parameter, number of SSBs per RACH occasion can be common for mapping SSBs to ROs in both sets of PRACH transmission occasions. The parameter, number of SSBs per RACH occasion for mapping SSBs to ROs can be separately signaled for the first and second set of PRACH transmission occasions. If the number of SSBs per RACH occasion for the second set of PRACH transmission occasions is not included in a random access configuration, UE 402 applies the number of SSBs per RACH occasion for the first set of PRACH transmission occasions also to the second set of PRACH transmission occasions.

The additional PRACH transmission occasions/resources configured in a random access configuration can be considered deactivated at the time UE 402 receives the random access configuration. Alternately, additional PRACH transmission occasions/resources configured in a random access configuration can be considered activated at the time UE 402 receives the random access configuration. Alternately, an initial state (activated or deactivated) of the additional PRACH transmission occasions/resources configured in a random access configuration at the time UE receives the random access configuration can be signaled by the network in the configuration.

In some embodiments to (de-)activate the additional PRACH transmission occasions/resources configured in a random access configuration, at operation 420 gNB 404 can transmit a PDCCH addressed to P-RNTI in a PO (or POs of an SI modification period or POs of a defaultPagingCycle or RACH adaptation cycle/interval). UE 402 monitors the PDCCH addressed to the P-RNTI in the PO to receive indication of (de-)activation of the additional PRACH transmission occasions/resources. The DCI in the transmitted PDCCH addressed to the P-RNTI in the PO indicates (de-)activation of additional ROs, and indicates the random access configuration for which additional ROs are (de-)activated. The DCI may include a parameter ra-ssb-OccasionMaskIndex to indicate activation of a subset of additional ROs.

In some embodiments, in order to indicate the random access configuration for which additional ROs are (de-)activated, the DCI may include at least one of an RA type (of the random access configuration for which additional ROs are activated), BWP info (e.g., identity) of the BWP of the random access configuration for which additional ROs are (de-)activated, and/or carrier type (NUL or SUL) of the random access configuration for which additional ROs are (de-)activated. In some embodiments, the carrier type is not included and additional ROs (de-)activation is only applied for the NUL. In some embodiments, BWP info is not included. In embodiments such as these, the BWP of the random access configuration for which additional ROs are (de-)activated is the active UL BWP at the time the DCI is received or the active UL BWP upon reception of the DCI. In some embodiments, BWP info is not included. In embodiments such as these, the BWP of the random access configuration for which additional ROs are (de-)activated is the initial UL BWP if the UE is in an RRC IDLE or RRC_INACTIVE state. In some embodiments, BWP info is not included. In embodiments such as these, the BWP of the random access configuration for which additional ROs are (de-)activated is the redcap specific initial UL BWP (if configured) if the UE is a redcap UE and is in an RRC IDLE or RRC_INACTIVE state and the DCI is received in a redcap specific initial DL BWP. In some embodiments, the BWP info is not included. In embodiments such as these, the BWP of the random access configuration for which additional ROs are (de-)activated is the initial UL BWP (if a redcap specific initial UL BWP is not configured) and if the UE is a redcap UE and is in an RRC IDLE or RRC_INACTIVE state and DCI is received in the redcap specific initial DL BWP. In embodiments such as these, if the UE is in RRC_CONNECTED, additional ROs are (de-)activated in the random access configuration(s) of the active UL BWP at the time the DCI indicating (de-)activation of additional ROs is received or the active UL BWP upon reception of the DCI indicating (de-)activation of additional ROs. In embodiments such as these, if the UE 402 is in an RRC_IDLE or RRC_INACTIVE state (i.e., UE 402 is not in an RRC_CONNECTED state), additional ROs are (de-)activated in the random access configuration(s) of the initial UL BWP upon reception of the DCI indicating (de-)activation of additional ROs. In embodiments such as these, if the UE 402 is in an RRC_IDLE or RRC_INACTIVE state (i.e., UE 402 is not in an RRC_CONNECTED state), additional ROs are (de-)activated in the random access configuration(s) of the initial UL BWP and redcap specific initial UL BWP (if configured) upon reception of the DCI indicating (de-)activation of additional ROs. In embodiments such as these, additional ROs are (de-)activated in the random access configuration(s) of the redcap specific initial UL BWP (if configured) if the UE 402 is a redcap UE and is in an RRC IDLE or RRC_INACTIVE state and the DCI indicating (de-)activation of additional ROs is received in a redcap specific initial DL BWP. In embodiments such as these, additional ROs are (de-)activated in the random access configuration(s) of the initial UL BWP (if a redcap specific initial UL BWP is not configured) and if the UE 402 is a redcap UE and is in an RRC IDLE or RRC_INACTIVE state and DCI indicating (de-)activation of additional ROs is received in the redcap specific initial DL BWP.

In some embodiments, if there are multiple random access configurations of the indicated RA type in the indicated BWP of the indicated carrier, the random access configuration index may be included in the DCI to indicate the random access configuration amongst these random access configurations for which additional ROs are (de-)activated. The random access configuration index associated with a random access configuration can be explicitly signaled in the random access configuration. Alternately, the random access configurations can be sequentially indexed in the order in which they are listed in a list of random access configurations.

In some embodiments, if there are multiple random access configurations of the indicated RA type in the indicated BWP of the indicated carrier, additional ROs can be configured only for one random access configuration and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs can be configured only for the random access configuration not associated with any feature and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs are considered (de-)activated for all random access configuration with additional ROs upon receiving the DCI (de-)activating additional ROs.

In some embodiments, the additional ROs are (de-)activated from the (or end of) an SI modification period or defaultPagingCycle or RACH adaptation cycle/interval in which the DCI (de-)activating additional ROs is received by UE 402.

In some embodiments, the (de-)activation of additional ROs and related information explained herein, may be included in the transport block (e.g., a paging message or MAC CE) scheduled by the DCI.

In some embodiments, UE 402 in an RRC_IDLE or in RRC_INACTIVE state while an SDT procedure is not ongoing shall monitor for a RACH adaptation indication (i.e., (de-)activation of the additional PRACH transmission occasions/resources) in UE 402's own paging occasion(s) that the UE 402 monitors for paging. Alternatively, in some embodiments, UE 402 in an RRC_IDLE or in RRC_INACTIVE state shall monitor for a RACH adaptation indication (i.e., (de-)activation of the additional PRACH transmission occasions/resources) UE 402's own paging occasion(s) that the UE 402 monitors for paging.

Alternatively, in some embodiments, for UE 402 in an RRC_INACTIVE state while an SDT procedure is ongoing, timer T319a is not running and if CG-SDT is selected and if extended CG-SDT periodicity is configured (i.e., cg-SDT-PeriodicityExt is configured), the UE 402 shall monitor for a RACH adaptation indication (i.e., (de-)activation of the additional PRACH transmission occasions/resources) in UE 402's own paging occasion(s) that the UE 402 monitors for paging. Otherwise, the UE 402 shall monitor for a RACH adaptation indication ((de-)activation of the additional PRACH transmission occasions/resources) in any paging occasion at least once per modification period, if the initial downlink BWP on which the SDT procedure is ongoing is associated with a CD-SSB.

In some embodiments, UE 402 in an RRC_CONNECTED state shall monitor for a RACH adaptation indication (i.e., (de-)activation of the additional PRACH transmission occasions/resources) in any paging occasion at least once per modification period if the UE 402 is provided with a common search space, including pagingSearchSpace, searchSpaceSIB1 and searchSpaceOtherSystemInformation, on the active BWP to monitor paging. In some embodiments, if multiple paging configurations are configured wherein one paging configuration is for paging frame adaptation/clustering/bundling and/or paging occasion adaptation/clustering/bundling, and another paging configuration is not for paging adaptation/clustering/bundling, UE 402 in an RRC_CONNECTED state shall monitor for a RACH adaptation indication (i.e., (de-)activation of the additional PRACH transmission occasions/resources) in any paging occasion except for the paging occasions configured only for paging adaptation/clustering/bundling (i.e., UE 402 shall monitor for a RACH adaptation indication in any paging occasion based on the other paging configuration) at least once per modification period if the UE 402 is provided with a common search space, including pagingSearchSpace, searchSpaceSIB1 and searchSpaceOtherSystemInformation, on the active BWP to monitor paging.

In some embodiments, UE 402 in an RRC_CONNECTED state shall monitor for a RACH adaptation indication (i.e., (de-)activation of the additional PRACH transmission occasions/resources) in any paging occasion at least once every defaultPagingCycle (or RACH adaptation cycle/interval configured by gNB) if the UE 402 is provided with a common search space, including pagingSearchSpace, searchSpaceSIB1 and searchSpaceOtherSystemInformation, on the active BWP to monitor paging. In some embodiments, if multiple paging configurations are configured wherein a first paging configuration is for paging frame adaptation/clustering/bundling and/or paging occasion adaptation/clustering/bundling, and a second paging configuration is not for paging adaptation/clustering/bundling, UE 402 in an RRC_CONNECTED state shall monitor for a RACH adaptation indication (i.e., (de-)activation of the additional PRACH transmission occasions/resources) in any paging occasion except for the paging occasions configured only for paging adaptation/clustering/bundling (i.e., UE 402 shall monitor for a RACH adaptation indication in any paging occasion based on second paging configuration) at least once every defaultPagingCycle (or RACH adaptation cycle/interval configured by gNB) if the UE 402 is provided with a common search space, including pagingSearchSpace, searchSpaceSIB1 and searchSpaceOtherSystemInformation, on the active BWP to monitor paging.

In some embodiments, UE 402 in an RRC_CONNECTED state may receive a RACH adaptation indication (i.e., (de-)activation of the additional PRACH transmission occasions/resources) in a dedicated RRC signaling message or MAC CE or DCI of a PDCCH addressed to a C-RNTI or group RNTI (the group RNTI can be pre-defined or signaled in a dedicated RRC message for RACH adaptation indication). This RACH adaptation indication may be received in case UE 402 is not provided with a common search space, including pagingSearchSpace, searchSpaceSIB1 and searchSpaceOtherSystemInformation, on the active BWP to monitor paging. If the UE 402 is not provided with a common search space, including pagingSearchSpace, searchSpaceSIB1 and searchSpaceOtherSystemInformation, on the active BWP to monitor paging, gNB 404 transmits the RACH adaptation indication (i.e., (de-)activation of the additional PRACH transmission occasions/resources) in a dedicated RRC signaling message or MAC CE or DCI of a PDCCH addressed to a C-RNTI or group RNTI (the group RNTI can be pre-defined or signaled in dedicated RRC message for RACH adaptation indication). If the UE 402 is provided with a common search space, including pagingSearchSpace, searchSpaceSIB1 and searchSpaceOtherSystemInformation, on the active BWP to monitor paging, gNB 404 transmits a RACH adaptation indication (i.e., (de-)activation of the additional PRACH transmission occasions/resources) in DCI of a PDCCH addressed to a P-RNTI.

In some embodiments, UE 402 in an RRC_CONNECTED state may receive a RACH adaptation indication (i.e., (de-)activation of the additional PRACH transmission occasions/resources) in a handover command or RRC reconfiguration message with reconfiguration with sync or LTM cell switch command MAC CE.

In some embodiments, UE 402 in an RRC_CONNECTED state may receive a PDCCH order to initiate a random access procedure towards a cell/serving cell wherein the PDCCH order may indicate activation of additional ROs and whether UE 402 should select an RO for random access preamble transmission from additional ROs configured in the random access configuration. Upon reception of the PDCCH order to initiate the random access procedure towards a cell/serving cell, UE 402 initiates the random access procedure, and UE selects a random access configuration.
In some embodiments, if the selected random access configuration is configured with additional ROs, UE 402 selects an RO from the additional ROs (i.e., ROs from the second set of PRACH transmission occasions in the random access configuration), if indicated in the PDCCH order or if the PDCCH order activates the additional ROs. Otherwise, UE 402 selects an RO from the first set of PRACH transmission occasions in the random access configuration. UE 402 transmits a random access preamble in the selected RO to the cell/serving cell.
Alternatively, in some embodiments, if the selected random access configuration is configured with additional ROs, UE 402 selects an RO from the additional ROs (i.e., ROs from the second set of PRACH transmission occasions in the random access configuration). UE 402 transmits a random access preamble in the selected RO to the cell/serving cell.
If the selected random access configuration is not configured with additional ROs, UE 402 selects an RO from the first set of PRACH transmission occasions in the random access configuration. UE 402 transmits a random access preamble in the selected RO to the cell/serving cell.

In some embodiments, UE 402 in an RRC_CONNECTED state may receive a PDCCH order to initiate a random access procedure towards a cell/serving cell. Upon reception of the PDCCH order to initiate the random access procedure towards a cell/serving cell, UE 402 initiates the random access procedure, and UE 402 selects a random access configuration.
In some embodiment, if the selected random access configuration is configured with additional ROs, UE 402 selects an RO from the additional ROs (i.e., ROs from the second set of PRACH transmission occasions in the random access configuration), if the additional ROs are activated. Otherwise, UE402 selects an RO from the first set of PRACH transmission occasions in the random access configuration. UE 402 transmits the random access preamble in the selected RO to the cell/serving cell.
Alternatively, in some embodiments, if the selected random access configuration is configured with additional ROs, UE 402 selects an RO from the additional ROs (i.e., ROs from the second set of PRACH transmission occasions in the random access configuration. UE 402 transmits a random access preamble in the selected RO to the cell/serving cell.
If the selected random access configuration is not configured with additional ROs, UE 402 selects an RO from the first set of PRACH transmission occasions in the random access configuration. UE 402 transmits a random access preamble in the selected RO to the cell/serving cell.

In some embodiments, UE 402 in an RRC_CONNECTED state may receive a handover command or RRC reconfiguration message with reconfiguration with sync or LTM cell switch command MAC CE to switch to a target cell, wherein the handover command or RRC reconfiguration message with reconfiguration with sync or LTM cell switch command MAC CE may indicate whether UE 402 should select an RO for a random access preamble transmission from additional ROs configured in a random access configuration. Upon reception of the handover command or RRC Reconfiguration message with reconfiguration with sync or LTM cell switch command MAC CE, UE 402 initiates a random access procedure towards the target cell, and UE selects a random access configuration.
In some embodiments, if the selected random access configuration is configured with additional ROs, UE 402 selects an RO from additional ROs (i.e., ROs from the second set of PRACH transmission occasions in the random access configuration), if indicated in the handover command or RRC Reconfiguration message with reconfiguration with sync or LTM cell switch command MAC CE. Otherwise, UE 402 selects an RO from the first set of PRACH transmission occasions in the random access configuration. UE 402 transmits a random access preamble in the selected RO to the target cell.
Alternatively, in some embodiments, if the selected random access configuration is configured with additional ROs, UE 402 selects an RO from additional ROs (i.e., ROs from the second set of PRACH transmission occasions in the random access configuration). UE 402 transmits a random access preamble in the selected RO to the target cell.
If the selected random access configuration is not configured with additional ROs, UE 402 selects an RO from the first set of PRACH transmission occasions in the random access configuration. UE 402 transmits a random access preamble in the selected RO to the target cell.

Although FIG. 4 illustrates one example procedure for activating additional ROs 400, various changes may be made to FIG. 4. For example, while shown as a series of operations, various operations in FIG. 4 could overlap, occur in parallel, occur in a different order, occur any number of times, be omitted, or replaced by other operations.

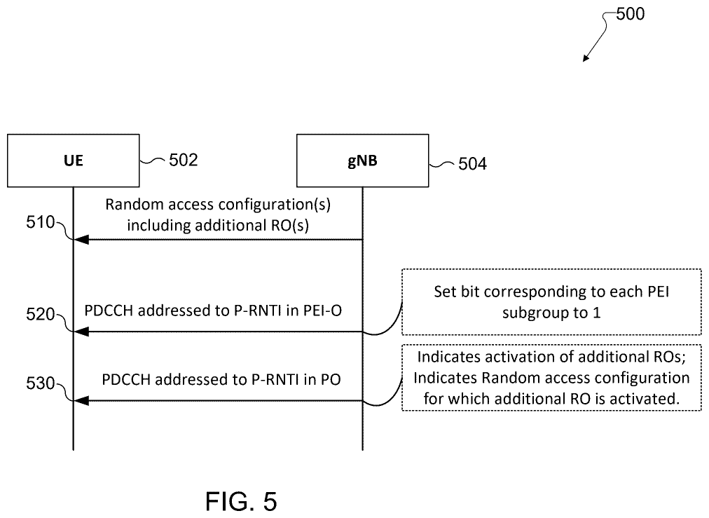

FIG. 5 illustrates another example procedure for activating additional ROs 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for activating additional ROs could be used without departing from the scope of this disclosure.

In the example of FIG. 5, at operation 510 a UE 502 receives one or more random access configurations from a gNB 504. Each random access configuration can be a 2 step random access configuration or 4 step random access configuration. These random access configurations can be received for one or more BWPs. Each random access configuration can be mapped to a feature or feature combination or not mapped to any feature. Example features include SDT, redcap, eRedcap, slicing, Msg3 repetition, Msg1 repetition, etc.

Each random access configuration includes parameters (prach-ConfigurationIndex, msg1-FrequencyStart and msg1-FDM) to configure a first set of PRACH transmission occasions (ROs). Each random access configuration may include a second set of PRACH transmission occasions (which may also be referred to as additional PRACH transmission occasions/resources). The additional PRACH transmission occasions/resources for a random access configuration can be signaled by including at least one of msg1-FrequencyStart, msg1-FDM, and/or prach-ConfigurationIndex separately for the additional PRACH transmission occasions/resources. The additional PRACH transmission occasions/resources can be configured in one or more of these random access configurations.

ROs in each of these two sets of PRACH transmission occasions are mapped to SSBs transmitted in the cell. The parameter, number of SSBs per RACH occasion can be common for mapping SSBs to ROs in both sets of PRACH transmission occasions. The parameter, number of SSBs per RACH occasion for mapping SSBs to ROs can be separately signaled for the first and second set of PRACH transmission occasions. If the number of SSBs per RACH occasion for the second set of PRACH transmission occasions is not included in the random access configuration, UE 502 applies the number of SSBs per RACH occasion for the first set of PRACH transmission occasions also to the second set of PRACH transmission occasions.

The additional PRACH transmission occasions/resources configured in a random access configuration can be considered deactivated at the time UE 502 receives the random access configuration. Alternately, additional PRACH transmission occasions/resources configured in a random access configuration can be considered activated at the time UE 502 receives the random access configuration. Alternately, an initial state (activated or deactivated) of the additional PRACH transmission occasions/resources configured in a random access configuration at the time UE 502 receives the random access configuration can be signaled by the network in the configuration.

In some embodiments to (de-)activate the additional PRACH transmission occasions/resources configured in a random access configuration, at operation 520 gNB 504 transmits a PDCCH addressed to a P-RNTI in a PEI-O. In the DCI of this PDCCH, gNB 504 sets a bit corresponding to each PEI subgroup to 1. At operation 530, gNB 504 then transmits a PDCCH addressed to a P-RNTI in a PO (or POs of an SI modification period or defaultPagingCycle or RACH adaptation cycle/interval). UE 502 monitors the PEI in its PEI-O. Upon receiving the PDCCH addressed to the P-RNTI in the PEI-O wherein the DCI includes a bit corresponding to the UE's PEI subgroup set to 1, UE 502 monitors the PDCCH addressed to the P-RNTI in the PO to receive an indication of (de-)activation of the additional PRACH transmission occasions/resources. The DCI in the transmitted PDCCH indicates (de-)activation of additional ROs, and indicates the random access configuration for which additional ROs are (de-)activated. The DCI may include a parameter ra-ssb-OccasionMaskIndex to indicate activation of a subset of additional ROs.

In some embodiments, in order to indicate the random access configuration for which additional ROs are (de-)activated, the DCI may include at least one of an RA type (of the random access configuration for which additional ROs are activated), BWP info (e.g., identity) of the BWP of the random access configuration for which additional ROs are (de-)activated, carrier type (NUL or SUL) of the random access configuration for which additional ROs are (de-)activated. In some embodiments, the carrier type is not included and additional ROs (de-)activation is only applied for NUL. In some embodiments, BWP info is not included. In embodiments such as these, the BWP of the random access configuration for which additional ROs are (de-)activated is the active UL BWP at the time the DCI is received or active UL BWP upon reception of the DCI. In some embodiments, BWP info is not included. In embodiments such as these, the BWP of the random access configuration for which additional ROs are (de-)activated is the initial UL BWP if the UE 502 is in an RRC IDLE or RRC_INACTIVE state. In some embodiments, BWP info is not included. In embodiments such as these, the BWP of the random access configuration for which additional ROs are (de-)activated is the redcap specific initial UL BWP (if configured) if UE 502 is a redcap UE and is in an RRC IDLE or RRC_INACTIVE state and the DCI is received in a redcap specific initial DL BWP. In some embodiments, BWP info is not included. In embodiments such as these, the BWP of the random access configuration for which additional ROs are (de-)activated is the initial UL BWP (if a redcap specific initial UL BWP is not configured) and if UE 502 is a redcap UE and is in an RRC IDLE or RRC_INACTIVE state and the DCI is received in a redcap specific initial DL BWP. In embodiments such as these, if the UE 502 is in an RRC_CONNECTED state, additional ROs are (de-)activated in the random access configuration(s) of the active UL BWP at the time the DCI indicating (de-)activation of additional ROs is received or the active UL BWP upon reception of the DCI indicating (de-)activation of additional ROs. In embodiments such as these, if the UE 502 is in an RRC_IDLE or RRC_INACTIVE state (i.e., UE 502 is not in an RRC_CONNECTED state), additional ROs are (de-)activated in the random access configuration(s) of the initial UL BWP upon reception of the DCI indicating (de-)activation of additional ROs. In embodiments such as these, if the UE 502 is in an RRC_IDLE or RRC_INACTIVE state (i.e., UE 505 is not in an RRC_CONNECTED state), additional ROs are (de-)activated in the random access configuration(s) of the initial UL BWP and redcap specific initial UL BWP (if configured) upon reception of the DCI indicating (de-)activation of additional ROs. In embodiments such as these, additional ROs are (de-)activated in the random access configuration(s) of the redcap specific initial UL BWP (if configured) if the UE 502 is a redcap UE and is in an RRC IDLE or RRC_INACTIVE state and the DCI indicating (de-)activation of additional ROs is received in a redcap specific initial DL BWP. In embodiments such as these, additional ROs are (de-)activated in the random access configuration(s) of the initial UL BWP (if a redcap specific initial UL BWP is not configured) and if the UE 502 is a redcap UE and is in an RRC IDLE or RRC_INACTIVE state and DCI indicating (de-)activation of additional ROs is received in the redcap specific initial DL BWP.

In some embodiments, if there are multiple random access configurations of the indicated RA type in the indicated BWP of the indicated carrier, a random access configuration index may be included in the DCI to indicate the random access configuration amongst these random access configurations for which additional ROs are (de-)activated. The random access configuration index associated with a random access configuration can be explicitly signaled in the random access configuration. Alternately, random access configurations can be sequentially indexed in the order in which they are listed in a list of random access configurations.

In some embodiments, if there are multiple random access configurations of the indicated RA type in the indicated BWP of the indicated carrier, additional ROs can be configured only for one random access configuration and additional ROs of this random access configuration are (de-)activated upon receiving the DCI (de-)activating the additional ROs.

In some embodiments, if there are multiple random access configurations of the indicated RA type in the indicated BWP of the indicated carrier, additional ROs can be configured only for the random access configuration not associated with any feature and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs are considered (de-)activated for all random access configuration with additional ROs upon receiving the DCI (de-)activating additional ROs.

In some embodiments, the additional ROs are (de-)activated from the end of an SI modification period or defaultPagingCycle or RACH adaptation cycle/interval in which the DCI (de-)activating additional ROs is received by UE.

Although FIG. 5 illustrates one example procedure for activating additional ROs 500, various changes may be made to FIG. 5. For example, while shown as a series of operations, various operations in FIG. 5 could overlap, occur in parallel, occur in a different order, occur any number of times, be omitted, or replaced by other operations.

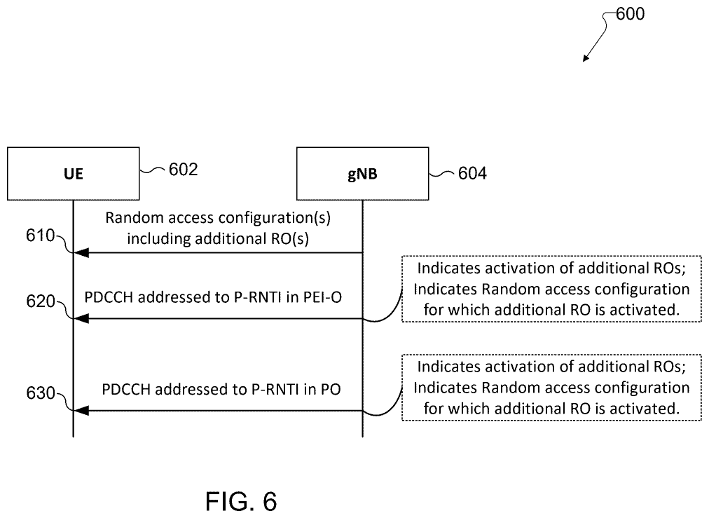

FIG. 6 illustrates another example procedure for activating additional ROs 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for activating additional ROs could be used without departing from the scope of this disclosure.

In the example of FIG. 6, at operation 610 a UE 602 receives one or more random access configurations from a gNB 604. Each random access configuration can be a 2 step random access configuration or 4 step random access configuration. These random access configurations can be received for one or more BWPs. Each random access configuration can be mapped to a feature or feature combination or not mapped to any feature. Example features include SDT, redcap, eRedcap, slicing, Msg3 repetition, Msg1 repetition, etc.

Each random access configuration includes parameters (prach-ConfigurationIndex, msg1-FrequencyStart and msg1-FDM) to configure a first set of PRACH transmission occasions (ROs). Each random access configuration may include a second set of PRACH transmission occasions (which may also be referred to as additional PRACH transmission occasions/resources). The additional PRACH transmission occasions/resources for a random access configuration can be signaled by including at least one of msg1-FrequencyStart, msg1-FDM, prach-ConfigurationIndex separately for additional PRACH transmission occasions/resources. The additional PRACH transmission occasions/resources can be configured in one or more of these random access configurations.

ROs in each of these two sets of PRACH transmission occasions are mapped to SSBs transmitted in the cell. The parameter, number of SSBs per RACH occasion can be common for mapping SSBs to ROs in both sets of PRACH transmission occasions. The parameter, number of SSBs per RACH occasion for mapping SSBs to ROs can be separately signaled for the first and second set of PRACH transmission occasions. If the number of SSBs per RACH occasion for the second set of PRACH transmission occasions is not included in the random access configuration, UE 602 applies the number of SSBs per RACH occasion for the first set of PRACH transmission occasions also to the second set of PRACH transmission occasions.

The additional PRACH transmission occasions/resources configured in a random access configuration can be considered deactivated at the time UE 602 receives the random access configuration. Alternately, additional PRACH transmission occasions/resources configured in a random access configuration can be considered activated at the time UE 602 receives the random access configuration. Alternately, an initial state (activated or deactivated) of additional PRACH transmission occasions/resources configured in a random access configuration at the time UE 602 receives the random access configuration can be signaled by the network in the configuration.

In some embodiments to (de-)activate the additional PRACH transmission occasions/resources configured in a random access configuration, at operation 620 gNB 604 transmits a PDCCH addressed to a P-RNTI in a PEI-O. At operation 630 gNB 604 then transmits a PDCCH addressed to a P-RNTI in a PO (or POs of SI modification period or defaultPagingCycle or RACH adaptation cycle/interval).

If UE 602 supports PEI, UE 602 monitors the PEI in its PEI-O to receive an indication of (de-)activation of the additional PRACH transmission occasions/resources. If UE 602 does not support PEI, UE 602 monitors the PDCCH addressed to the P-RNTI in the PO to receive an indication of (de-)activation of the additional PRACH transmission occasions/resources.

The DCI in the transmitted PDCCH in the PEI-O and PO indicates (de-)activation of additional ROs, and indicates a random access configuration for which additional ROs are (de-)activated. The DCI may include a parameter ra-ssb-OccasionMaskIndex to indicate activation of a subset of additional ROs.

In some embodiments, in order to indicate the random access configuration for which additional ROs are (de-)activated, the DCI may include at least one of an RA type (of the random access configuration for which additional ROs are activated), BWP info (e.g., identity) of the BWP of the random access configuration for which additional ROs are (de-)activated, and/or carrier type (NUL or SUL) of the random access configuration for which additional ROs are (de-)activated. In some embodiments, the carrier type is not included and additional ROs (de-)activation is only applied for the NUL. In some embodiments, BWP info is not included. In embodiments such as these, the BWP of the random access configuration for which additional ROs are (de-)activated is the active UL BWP at the time the DCI is received or the active UL BWP upon reception of the DCI. In some embodiments, BWP info is not included. In embodiments such as these, the BWP of the random access configuration for which additional ROs are (de-)activated is the initial UL BWP if UE 602 is in an RRC IDLE or RRC_INACTIVE state. In some embodiments, BWP info is not included. In embodiments such as these, the BWP of the random access configuration for which additional ROs are (de-)activated is the redcap specific initial UL BWP (if configured) if UE 602 is a redcap UE and is in an RRC IDLE or RRC_INACTIVE state and the DCI is received in a redcap specific initial DL BWP. In some embodiments, BWP info is not included. In embodiments such as these, the BWP of the random access configuration for which additional ROs are (de-)activated is the initial UL BWP (if a redcap specific initial UL BWP is not configured) and if UE 602 is a redcap UE and is in an RRC IDLE or RRC_INACTIVE state and the DCI is received in a redcap specific initial DL BWP. In embodiments such as these, if the UE 602 is in an RRC_CONNECTED state, additional ROs are (de-)activated in the random access configuration(s) of the active UL BWP at the time the DCI indicating (de-)activation of additional ROs is received or the active UL BWP upon reception of the DCI indicating (de-)activation of additional ROs. In embodiments such as these, if the UE 602 is in an RRC_IDLE or RRC_INACTIVE (i.e., UE 602 is not in an RRC_CONNECTED state), additional ROs are (de-)activated in the random access configuration(s) of the initial UL BWP upon reception of the DCI indicating (de-)activation of additional ROs. In embodiments such as these, if the UE 602 is in an RRC_IDLE or RRC_INACTIVE state (i.e., UE 602 is not in an RRC_CONNECTED state), additional ROs are (de-)activated in the random access configuration(s) of the initial UL BWP and redcap specific initial UL BWP (if configured) upon reception of the DCI indicating (de-)activation of additional ROs. In embodiments such as these, additional ROs are (de-)activated in the random access configuration(s) of the redcap specific initial UL BWP (if configured) if the UE 602 is a redcap UE and is in an RRC IDLE or RRC_INACTIVE state and the DCI indicating (de-)activation of additional ROs is received in a redcap specific initial DL BWP. In embodiments such as these, additional ROs are (de-)activated in the random access configuration(s) of the initial UL BWP (if a redcap specific initial UL BWP is not configured) and if the UE 602 is a redcap UE and is in an RRC IDLE or RRC_INACTIVE state and DCI indicating (de-)activation of additional ROs is received in the redcap specific initial DL BWP.

In some embodiments, if there are multiple random access configurations of the indicated RA type in the indicated BWP of the indicated carrier, a random access configuration index may be included in the DCI to indicate the random access configuration amongst these random access configurations for which additional ROs are (de-)activated. The random access configuration index associated with a random access configuration can be explicitly signaled in the random access configuration. Alternately, the random access configurations can be sequentially indexed in the order in which they are listed in a list of random access configurations.

In some embodiments, if there are multiple random access configurations of the indicated RA type in the indicated BWP of the indicated carrier, additional ROs can be configured only for one random access configuration and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs can be configured only for the random access configuration not associated with any feature and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs are considered (de-)activated for all random access configurations with additional ROs upon receiving the DCI (de-)activating additional ROs.

In some embodiments, the additional ROs are (de-)activated from the end of an SI modification period or defaultPagingCycle or RACH adaptation cycle/interval in which the DCI (de-)activating additional ROs is received by UE 602.

Although FIG. 6 illustrates one example procedure for activating additional ROs 600, various changes may be made to FIG. 6. For example, while shown as a series of operations, various operations in FIG. 6 could overlap, occur in parallel, occur in a different order, occur any number of times, be omitted, or replaced by other operations.

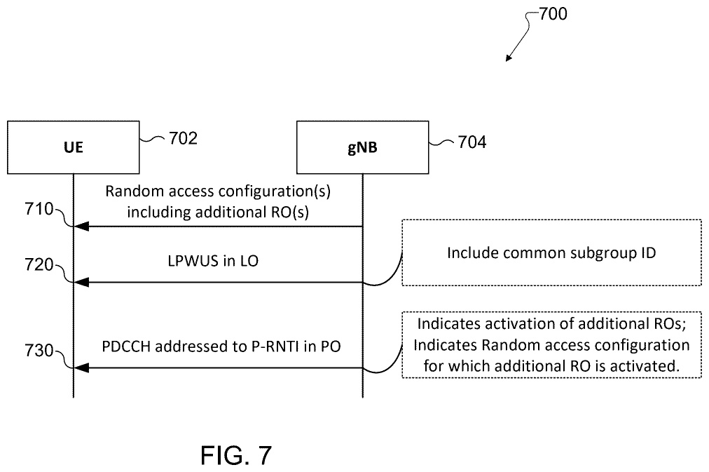

FIG. 7 illustrates another example procedure for activating additional ROs 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for activating additional ROs could be used without departing from the scope of this disclosure.

In the example of FIG. 7, at operation 710 a UE 702 receives one or more random access configurations from a gNB 704. Each random access configuration can be a 2 step random access configuration or 4 step random access configuration. These random access configurations can be received for one or more BWPs. Each random access configuration can be mapped to a feature or feature combination or not mapped to any feature. Example features include SDT, redcap, eRedcap, slicing, Msg3 repetition, Msg1 repetition, etc.

Each random access configuration includes parameters (prach-ConfigurationIndex, msg1-FrequencyStart and msg1-FDM) to configure a first set of PRACH transmission occasions (ROs). Each random access configuration may include a second set of PRACH transmission occasions (which may also be referred to as additional PRACH transmission occasions/resources). The additional PRACH transmission occasions/resources for a random access configuration can be signaled by including at least one of msg1-FrequencyStart, msg1-FDM, prach-ConfigurationIndex separately for the additional PRACH transmission occasions/resources. The additional PRACH transmission occasions/resources can be configured in one or more of these random access configurations.

ROs in each of these two sets of PRACH transmission occasions are mapped to SSBs transmitted in the cell. The parameter, number of SSBs per RACH occasion can be common for mapping SSBs to ROs in both sets of PRACH transmission occasions. The parameter, number of SSBs per RACH occasion for mapping SSBs to ROs can be separately signaled for the first and second set of PRACH transmission occasions. If the number of SSBs per RACH occasion for the second set of PRACH transmission occasions is not included in the random access configuration, UE 702 applies the number of SSBs per RACH occasion for the first set of PRACH transmission occasions also to the second set of PRACH transmission occasions.

The additional PRACH transmission occasions/resources configured in a random access configuration can be considered deactivated at the time UE 702 receives the random access configuration. Alternately, additional PRACH transmission occasions/resources configured in a random access configuration can be considered activated at the time UE 702 receives the random access configuration. Alternately, an initial state (activated or deactivated) of the additional PRACH transmission occasions/resources configured in a random access configuration at the time UE 702 receives the random access configuration can be signaled by the network in the configuration.

In some embodiments to (de-)activate the additional PRACH transmission occasions/resources configured in a random access configuration, at operation 720 gNB 704 transmits an LPWUS in an LO. In the LPWUS, gNB 704 includes a common subgroup ID or a code point common for all UEs. At operation 730, gNB 704 then transmits a PDCCH addressed to a P-RNTI in a PO (or POs of an SI modification period or defaultPagingCycle or RACH adaptation cycle/interval). UE 702 monitors the LPWUS in the LO using a low power receiver (LR). Upon receiving the LPWUS in the LO including the common subgroup ID or a code point common for all UEs, UE 702 monitors the PDCCH addressed to the P-RNTI in the PO using its main radio (MR) to receive an indication of (de-)activation of the additional PRACH transmission occasions/resources. The DCI in the transmitted PDCCH indicates (de-)activation of the additional ROs, and indicates the random access configuration for which additional ROs are (de-)activated. The DCI may include a parameter ra-ssb-OccasionMaskIndex to indicate activation of a subset of additional ROs.

In some embodiments, in order to indicate the random access configuration for which additional ROs are (de-)activated, the DCI may include at least one of an RA type (of random access configuration for which additional ROs are activated), BWP info (e.g., identity) of the BWP of the random access configuration for which additional ROs are (de-)activated, and/or carrier type (NUL or SUL) of the random access configuration for which additional ROs are (de-)activated. In some embodiments, the carrier type is not included and additional ROs (de-)activation is only applied for the NUL. In some embodiments, BWP info is not included. In embodiments such as these, the BWP of the random access configuration for which additional ROs are (de-)activated is the active UL BWP at the time the DCI is received or active UL BWP upon reception of the DCI. In some embodiments, BWP info is not included. In embodiments such as these, the BWP of the random access configuration for which additional ROs are (de-)activated is the initial UL BWP if UE 702 is in an RRC IDLE or RRC_INACTIVE state. In some embodiments, BWP info is not included. In embodiments such as these, the BWP of the random access configuration for which additional ROs are (de-)activated is the redcap specific initial UL BWP (if configured) if UE 702 is a redcap UE and is in an RRC IDLE or RRC_INACTIVE state and the DCI is received in a redcap specific initial DL BWP. In some embodiments, BWP info is not included. In embodiments such as these, the BWP of the random access configuration for which additional ROs are (de-)activated is the initial UL BWP (if a redcap specific initial UL BWP is not configured) and if UE 702 is a redcap UE and is in an RRC IDLE or RRC_INACTIVE state and the DCI is received in a redcap specific initial DL BWP. In embodiments such as these, if the UE 702 is in and RRC_CONNECTED state, additional ROs are (de-)activated in the random access configuration(s) of the active UL BWP at the time the DCI indicating (de-)activation of additional ROs is received or the active UL BWP upon reception of the DCI indicating (de-)activation of additional ROs. In embodiments such as these, if the UE 702 is in an RRC_IDLE or RRC_INACTIVE state (i.e., UE 702 is not in an RRC_CONNECTED state), additional ROs are (de-)activated in the random access configuration(s) of the initial UL BWP upon reception of the DCI indicating (de-)activation of additional ROs. In embodiments such as these, if the UE 702 is in an RRC_IDLE or RRC_INACTIVE state (i.e., the UE is not in an RRC_CONNECTED state), additional ROs are (de-)activated in the random access configuration(s) of the initial UL BWP and redcap specific initial UL BWP (if configured) upon reception of the DCI indicating (de-)activation of additional ROs. In embodiments such as these, additional ROs are (de-)activated in the random access configuration(s) of the redcap specific initial UL BWP (if configured) if the UE 702 is a redcap UE and is in an RRC IDLE or RRC_INACTIVE state and the DCI indicating (de-)activation of additional ROs is received in a redcap specific initial DL BWP. In embodiments such as these, additional ROs are (de-)activated in the random access configuration(s) of the initial UL BWP (if a redcap specific initial UL BWP is not configured) and if the UE 702 is a redcap UE and is in an RRC IDLE or RRC_INACTIVE state and DCI indicating (de-)activation of additional ROs is received in the redcap specific initial DL BWP.

In some embodiments, if there are multiple random access configurations of the indicated RA type in the indicated BWP of the indicated carrier, a random access configuration index may be included in the DCI to indicate the random access configuration amongst these random access configurations for which additional ROs are (de-)activated. The random access configuration index associated with a random access configuration can be explicitly signaled in the random access configuration. Alternately, random access configurations can be sequentially indexed in the order in which they are listed in a list of random access configurations.

In some embodiments, if there are multiple random access configurations of the indicated RA type in the indicated BWP of the indicated carrier, additional ROs can be configured only for one random access configuration and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs can be configured only for the random access configuration not associated with any feature and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs are considered (de-)activated for all random access configuration with additional ROs upon receiving the DCI (de-)activating additional ROs.

In some embodiments, the additional ROs are (de-)activated from the end of an SI modification period or defaultPagingCycle or RACH adaptation cycle/interval in which the DCI (de-)activating additional ROs is received by UE 702.

Although FIG. 7 illustrates one example procedure for activating additional ROs 700, various changes may be made to FIG. 7. For example, while shown as a series of operations, various operations in FIG. 7 could overlap, occur in parallel, occur in a different order, occur any number of times, be omitted, or replaced by other operations.

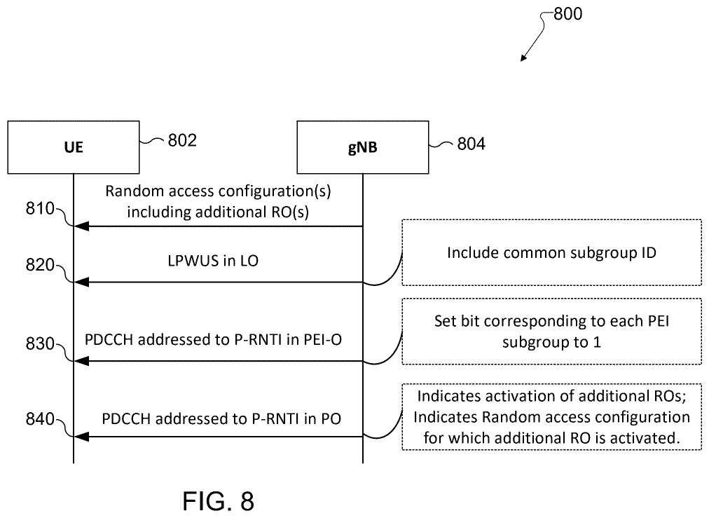

FIG. 8 illustrates another example procedure for activating additional ROs 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for activating additional ROs could be used without departing from the scope of this disclosure.

In the example of FIG. 8, at operation 810 a UE 802 receives one or more random access configurations from a gNB 804. Each random access configuration can be a 2 step random access configuration or 4 step random access configuration. These random access configurations can be received for one or more BWPs. Each random access configuration can be mapped to a feature or feature combination or not mapped to any feature. Example features include SDT, redcap, eRedcap, slicing, Msg3 repetition, Msg1 repetition, etc.

Each random access configuration includes parameters (prach-ConfigurationIndex, msg1-FrequencyStart and msg1-FDM) to configure a first set of PRACH transmission occasions (ROs). Each random access configuration may include a second set of PRACH transmission occasions (which may also be referred to as additional PRACH transmission occasions/resources). The additional PRACH transmission occasions/resources for a random access configuration can be signaled by including at least one of msg1-FrequencyStart, msg1-FDM, and/or prach-ConfigurationIndex separately for additional PRACH transmission occasions/resources. The additional PRACH transmission occasions/resources can be configured in one or more of these random access configurations.

ROs in each of these two sets of PRACH transmission occasions are mapped to SSBs transmitted in the cell. The parameter, number of SSBs per RACH occasion can be common for mapping SSBs to ROs in both sets of PRACH transmission occasions. The parameter, number of SSBs per RACH occasion for mapping SSBs to ROs can be separately signaled for the first and second set of PRACH transmission occasions. If the number of SSBs per RACH occasion for the second set of PRACH transmission occasions is not included in the random access configuration, UE 802 applies the number of SSBs per RACH occasion for the first set of PRACH transmission occasions also to the second set of PRACH transmission occasions.

The additional PRACH transmission occasions/resources configured in a random access configuration can be considered deactivated at the time UE 802 receives the random access configuration. Alternately, additional PRACH transmission occasions/resources configured in a random access configuration can be considered activated at the time UE 802 receives the random access configuration. Alternately, an initial state (activated or deactivated) of additional PRACH transmission occasions/resources configured in a random access configuration at the time UE 802 receives the random access configuration can be signaled by the network in the configuration.

In some embodiments to (de-)activate the additional PRACH transmission occasions/resources configured in a random access configuration, at operation 820 gNB 804 transmits an LPWUS in an LO. In the LPWUS, gNB 804 includes a common subgroup ID or a code point common for all UEs. At operation 830, gNB 804 then transmits a PDCCH addressed to a P-RNTI in a PEI-O. In the DCI of this PDCCH, gNB 804 sets a bit corresponding to each PEI subgroup to 1. At operation 840m gNB 840 then transmits a PDCCH addressed to a P-RNTI in a PO (or POs of SI modification period or defaultPagingCycle or RACH adaptation cycle/interval).

UE 802 monitors the LPWUS in its LO using a low power receiver (LR). Upon receiving the LPWUS in the LO including the common subgroup ID or a code point common for all UEs, UE 802 monitors the PDCCH addressed to the P-RNTI in the PEI-O using its main radio (MR). Upon receiving the PDCCH addressed to the P-RNTI in the PEI-O, wherein the DCI includes a bit corresponding to UE 802's PEI subgroup set to 1, UE 802 monitors the PDCCH addressed to the P-RNTI in the PO to receive an indication of (de-)activation of the additional PRACH transmission occasions/resources. The DCI in the transmitted PDCCH indicates (de-)activation of additional ROs, and indicates a random access configuration for which additional ROs are (de-)activated. The DCI may include a parameter ra-ssb-OccasionMaskIndex to indicate activation of a subset of additional ROs.

In some embodiments, in order to indicate the random access configuration for which additional ROs are (de-)activated, the DCI may include at least one of an RA type (of the random access configuration for which additional ROs are activated), BWP info (e.g., identity) of the BWP of the random access configuration for which additional ROs are (de-)activated, and/or carrier type (NUL or SUL) of the random access configuration for which additional ROs are (de-)activated. In some embodiments, BWP info is not included. In embodiments such as these, the BWP of the random access configuration for which additional ROs are (de-)activated is the active UL BWP at the time the DCI is received or the active UL BWP upon reception of the DCI. In some embodiments, BWP info is not included. In embodiments such as these, the BWP of the random access configuration for which additional ROs are (de-)activated is the initial UL BWP if UE 802 is in an RRC IDLE or RRC_INACTIVE state. In some embodiments, the carrier type is not included and additional ROs (de-)activation is only applied for the NUL. In some embodiments, BWP info is not included. In embodiments such as these, the BWP of the random access configuration for which additional ROs are (de-)activated is the redcap specific initial UL BWP (if configured) if UE 802 is a redcap UE and is in an RRC IDLE or RRC_INACTIVE state and the DCI is received in a redcap specific initial DL BWP. In some embodiments, BWP info is not included. In embodiments such as these, the BWP of the random access configuration for which additional ROs are (de-)activated is the initial UL BWP (if a redcap specific initial UL BWP is not configured) and if UE 802 is a redcap UE and is in an RRC IDLE or RRC_INACTIVE state and the DCI is received in a redcap specific initial DL BWP. In embodiments such as these, if the UE 802 is in an RRC_CONNECTED state, additional ROs are (de-)activated in the random access configuration(s) of the active UL BWP at the time the DCI indicating (de-)activation of additional ROs is received or the active UL BWP upon reception of the DCI indicating (de-)activation of additional ROs. In embodiments such as these, if the UE 802 is in an RRC_IDLE or RRC_INACTIVE state (i.e., UE 802 is not in an RRC_CONNECTED state), additional ROs are (de-)activated in the random access configuration(s) of the initial UL BWP upon reception of the DCI indicating (de-)activation of additional ROs. In embodiments such as these, if the UE 802 is in an RRC_IDLE or RRC_INACTIVE state (i.e., UE 802 is not in an RRC_CONNECTED state), additional ROs are (de-)activated in the random access configuration(s) of the initial UL BWP and redcap specific initial UL BWP (if configured) upon reception of the DCI indicating (de-)activation of additional ROs. In embodiments such as these, additional ROs are (de-)activated in the random access configuration(s) of the redcap specific initial UL BWP (if configured) if the UE 802 is a redcap UE and is in an RRC IDLE or RRC_INACTIVE state and the DCI indicating (de-)activation of additional ROs is received in a redcap specific initial DL BWP. In embodiments such as these, additional ROs are (de-)activated in the random access configuration(s) of the initial UL BWP (if a redcap specific initial UL BWP is not configured) and if the UE 802 is a redcap UE and is in an RRC IDLE or RRC_INACTIVE state and DCI indicating (de-)activation of additional ROs is received in the redcap specific initial DL BWP.

In some embodiments, if there are multiple random access configurations of the indicated RA type in the indicated BWP of the indicated carrier, a random access configuration index may be included in the DCI to indicate the random access configuration amongst these random access configurations for which additional ROs are (de-)activated. The random access configuration index associated with a random access configuration can be explicitly signaled in the random access configuration. Alternately, random access configurations can be sequentially indexed in the order in which they are listed in a list of random access configurations.

In some embodiments, if there are multiple random access configurations of the indicated RA type in the indicated BWP of the indicated carrier, additional ROs can be configured only for one random access configuration and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs can be configured only for the random access configuration not associated with any feature and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs are considered (de-)activated for all random access configurations with additional ROs upon receiving the DCI (de-)activating additional ROs.

In some embodiments, the additional ROs are (de-)activated from the end of an SI modification period or defaultPagingCycle or RACH adaptation cycle/interval in which the DCI (de-)activating additional ROs is received by UE 802.

Although FIG. 8 illustrates one example procedure for activating additional ROs 800, various changes may be made to FIG. 8. For example, while shown as a series of operations, various operations in FIG. 8 could overlap, occur in parallel, occur in a different order, occur any number of times, be omitted, or replaced by other operations.

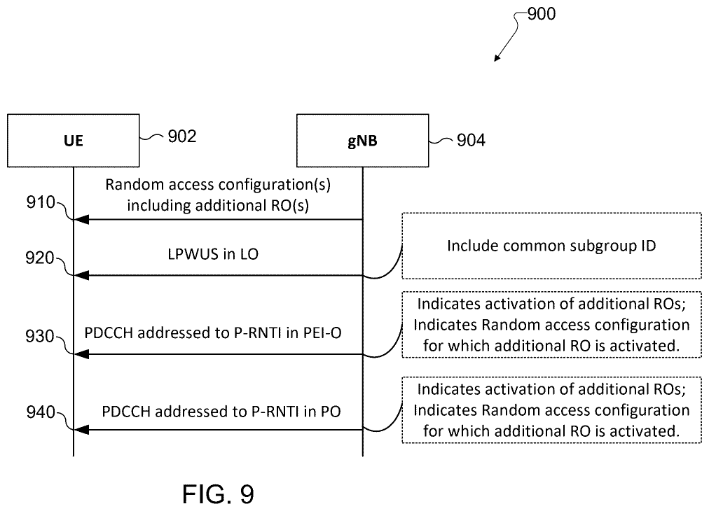

FIG. 9 illustrates another example procedure for activating additional ROs 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for activating additional ROs could be used without departing from the scope of this disclosure.

In the example of FIG. 9, at operation 910 a UE 902 receives one or more random access configurations from a gNB 904. Each random access configuration can be a 2 step random access configuration or 4 step random access configuration. These random access configurations can be received for one or more BWPs. Each random access configuration can be mapped to a feature or feature combination or not mapped to any feature. Example features include SDT, redcap, eRedcap, slicing, Msg3 repetition, Msg1 repetition, etc.

Each random access configuration includes parameters (prach-ConfigurationIndex, msg1-FrequencyStart and msg1-FDM) to configure a first set of PRACH transmission occasions (ROs). Each random access configuration may include a second set of PRACH transmission occasions (which may also be referred to as additional PRACH transmission occasions/resources). The additional PRACH transmission occasions/resources for a random access configuration can be signaled by including at least one of msg1-FrequencyStart, msg1-FDM, and/or prach-ConfigurationIndex separately for additional PRACH transmission occasions/resources. The additional PRACH transmission occasions/resources can be configured in one or more of these random access configurations.

ROs in each of these two sets of PRACH transmission occasions are mapped to SSBs transmitted in the cell. The parameter, number of SSBs per RACH occasion can be common for mapping SSBs to ROs in both sets of PRACH transmission occasions. The parameter, number of SSBs per RACH occasion for mapping SSBs to ROs can be separately signaled for the first and second set of PRACH transmission occasions. If the number of SSBs per RACH occasion for the second set of PRACH transmission occasions is not included in the random access configuration, UE 902 applies the number of SSBs per RACH occasion for the first set of PRACH transmission occasions also to the second set of PRACH transmission occasions.

The additional PRACH transmission occasions/resources configured in a random access configuration can be considered deactivated at the time UE 902 receives the random access configuration. Alternately, additional PRACH transmission occasions/resources configured in a random access configuration can be considered activated at the time UE 902 receives the random access configuration. Alternately, an initial state (activated or deactivated) of additional PRACH transmission occasions/resources configured in a random access configuration at the time UE 902 receives the random access configuration can be signaled by the network in the configuration.

In some embodiments to (de-)activate the additional PRACH transmission occasions/resources configured in a random access configuration, at operation 920 gNB 904 transmits an LPWUS in an LO. In the LPWUS, gNB 904 includes a common subgroup ID or a code point common for all UEs. At operation 930, gNB 904 then transmits a PDCCH addressed to a P-RNTI in a PEI-O. At operation 940, gNB 904 then transmits a PDCCH addressed to a P-RNTI in a PO (or POs of SI modification period or defaultPagingCycle or RACH adaptation cycle/interval).

UE 902 monitors the LPWUS in its LO using a low power receiver (LR). Upon receiving the LPWUS in the LO including a common subgroup ID or a code point common for all UEs, if UE 902 supports PEI, UE 902 monitors the PDCCH addressed to P-RNTI in PEI-O using its main radio (MR). Upon receiving the LPWUS in the LO including a common subgroup ID or a code point common for all UEs, if UE 902 does not support PEI, UE 902 monitors the PDCCH addressed to the P-RNTI in the PO using the main radio (MR).

The DCI in the transmitted PDCCH in the PEI-O and PO indicates (de-)activation of additional ROs, and indicates the random access configuration for which additional ROs are (de-)activated. The DCI may include a parameter ra-ssb-OccasionMaskIndex to indicate activation of subset of additional ROs.

In some embodiments, in order to indicate the random access configuration for which additional ROs are (de-)activated, the DCI may include at least one of an RA type (of the random access configuration for which additional ROs are activated), BWP info (e.g., identity) of the BWP of the random access configuration for which additional ROs are (de-)activated, and/or carrier type (NUL or SUL) of the random access configuration for which additional ROs are (de-)activated. In some embodiments, BWP info is not included. In embodiments such as these, the BWP of the random access configuration for which additional ROs are (de-)activated is the active UL BWP at the time the DCI is received or the active UL BWP upon reception of the DCI. In some embodiments, BWP info is not included. In embodiments such as these, the BWP of the random access configuration for which additional ROs are (de-)activated is the initial UL BWP if UE 902 is in and RRC IDLE or RRC_INACTIVE state. In some embodiments, BWP info is not included. In embodiments such as these, the BWP of the random access configuration for which additional ROs are (de-)activated is the redcap specific initial UL BWP (if configured) if UE 902 is a redcap UE and is in an RRC IDLE or RRC_INACTIVE state and the DCI is received in a redcap specific initial DL BWP. In some embodiments, BWP info is not included. In embodiments such as these, the BWP of the random access configuration for which additional ROs are (de-)activated is the initial UL BWP (if a redcap specific initial UL BWP is not configured) and if UE 902 is a redcap UE and is in an RRC IDLE or RRC_INACTIVE state and the DCI is received in a redcap specific initial DL BWP. In embodiments such as these, if the UE 902 is in RRC_CONNECTED state, additional ROs are (de-)activated in the random access configuration(s) of the active UL BWP at the time the DCI indicating (de-)activation of additional ROs is received or the active UL BWP upon reception of the DCI indicating (de-)activation of additional ROs. In embodiments such as these, if the UE 902 is in an RRC_IDLE or RRC_INACTIVE state (i.e., UE 902 is not in an RRC_CONNECTED state), additional ROs are (de-)activated in the random access configuration(s) of the initial UL BWP upon reception of the DCI indicating (de-)activation of additional ROs. In embodiments such as these, if the UE 902 is in an RRC_IDLE or RRC_INACTIVE state (i.e., UE 902 is not in an RRC_CONNECTED state), additional ROs are (de-)activated in the random access configuration(s) of the initial UL BWP and redcap specific initial UL BWP (if configured) upon reception of the DCI indicating (de-)activation of additional ROs. In embodiments such as these, additional ROs are (de-)activated in the random access configuration(s) of the redcap specific initial UL BWP (if configured) if the UE 902 is a redcap UE and is in an RRC IDLE or RRC_INACTIVE state and the DCI indicating (de-)activation of additional ROs is received in a redcap specific initial DL BWP. In embodiments such as these, additional ROs are (de-)activated in the random access configuration(s) of the initial UL BWP (if a redcap specific initial UL BWP is not configured) and if the UE 902 is a redcap UE and is in an RRC IDLE or RRC_INACTIVE state and DCI indicating (de-)activation of additional ROs is received in the redcap specific initial DL BWP.

In some embodiments, if there are multiple random access configurations of the indicated RA type in the indicated BWP of the indicated carrier, a random access configuration index may be included in the DCI to indicate the random access configuration amongst these random access configurations for which additional ROs are (de-)activated. The random access configuration index associated with a random access configuration can be explicitly signaled in the random access configuration. Alternately, random access configurations can be sequentially indexed in the order in which they are listed in a list of random access configurations.

In some embodiments, if there are multiple random access configurations of the indicated RA type in the indicated BWP of the indicated carrier, additional ROs can be configured only for one random access configuration and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs can be configured only for the random access configuration not associated with any feature and additional ROs of this random access configuration are (de-)activated upon receiving the DCI (de-)activating additional ROs.

In some embodiments, if there are multiple random access configurations of the indicated RA type in the indicated BWP of the indicated carrier, additional ROs are considered (de-)activated for all random access configurations with additional ROs upon receiving the DCI (de-)activating additional ROs.

In some embodiments, the additional ROs are (de-)activated from the end of an SI modification period or defaultPagingCycle or RACH adaptation cycle/interval in which the DCI (de-)activating additional ROs is received by UE 902.

Although FIG. 9 illustrates one example procedure for activating additional ROs 900, various changes may be made to FIG. 9. For example, while shown as a series of operations, various operations in FIG. 9 could overlap, occur in parallel, occur in a different order, occur any number of times, be omitted, or replaced by other operations.

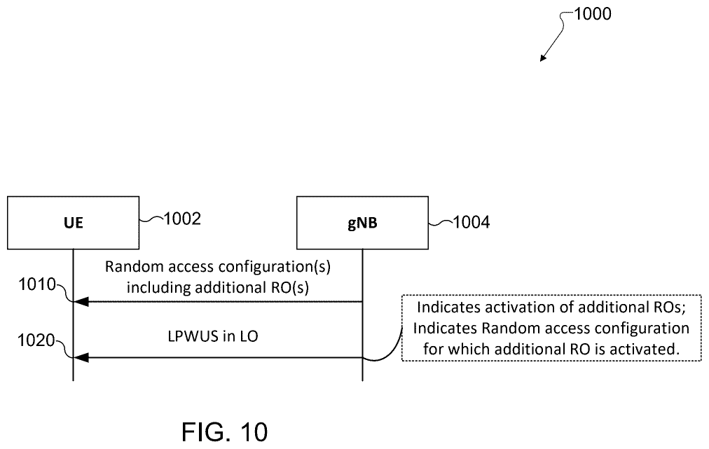

FIG. 10 illustrates another example procedure for activating additional ROs 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for activating additional ROs could be used without departing from the scope of this disclosure.

In the example of FIG. 10, at operation 1010 a UE 1002 receives one or more random access configurations from a gNB 1004. Each random access configuration can be a 2 step random access configuration or 4 step random access configuration. These random access configurations can be received for one or more BWPs. Each random access configuration can be mapped to a feature or feature combination or not mapped to any feature. Example features include SDT, redcap, eRedcap, slicing, Msg3 repetition, Msg1 repetition, etc.

Each random access configuration includes parameters (prach-ConfigurationIndex, msg1-FrequencyStart and msg1-FDM) to configure a first set of PRACH transmission occasions (ROs). Each random access configuration may include a second set of PRACH transmission occasions (which may also be referred to as additional PRACH transmission occasions/resources). The additional PRACH transmission occasions/resources for a random access configuration can be signaled by including at least one of msg1-FrequencyStart, msg1-FDM, and/or prach-ConfigurationIndex separately for additional PRACH transmission occasions/resources. The additional PRACH transmission occasions/resources can be configured in one or more of these random access configurations.

ROs in each of these two sets of PRACH transmission occasions are mapped to SSBs transmitted in the cell. The parameter, number of SSBs per RACH occasion can be common for mapping SSBs to ROs in both sets of PRACH transmission occasions. The parameter, number of SSBs per RACH occasion for mapping SSBs to ROs can be separately signaled for the first and second set of PRACH transmission occasions. If the number of SSBs per RACH occasion for the second set of PRACH transmission occasions is not included in the random access configuration, UE 1002 applies the number of SSBs per RACH occasion for the first set of PRACH transmission occasions also to the second set of PRACH transmission occasions.

The additional PRACH transmission occasions/resources configured in a random access configuration can be considered deactivated at the time UE 1002 receives the random access configuration. Alternately, additional PRACH transmission occasions/resources configured in a random access configuration can be considered activated at the time UE 1002 receives the random access configuration. Alternately, an initial state (activated or deactivated) of additional PRACH transmission occasions/resources configured in a random access configuration at the time UE 1002 receives the random access configuration can be signaled by the network in the configuration.

In some embodiments to (de-)activate the additional PRACH transmission occasions/resources configured in a random access configuration, at operation 1020 gNB 1004 transmits an LPWUS in an LO.

The LPWUS indicates (de-)activation of additional ROs, and indicates a random access configuration for which additional ROs are (de-)activated. The LPWUS may include a parameter ra-ssb-OccasionMaskIndex to indicate activation of a subset of additional ROs.

In some embodiments, in order to indicate the random access configuration for which additional ROs are (de-)activated, the LPWUS may include at least one of an RA type (of the random access configuration for which additional ROs are activated), BWP info (e.g., identity) of the BWP of the random access configuration for which additional ROs are (de-)activated, and/or carrier type (NUL or SUL) of the random access configuration for which additional ROs are (de-)activated. In some embodiments, the carrier type is not included and additional ROs (de-)activation is only applied for the NUL. In some embodiments, BWP info is not included. In embodiments such as these, the BWP of the random access configuration for which additional ROs are (de-)activated is the active UL BWP at the time the LPWUS is received or the active UL BWP upon reception of the LPWUS. In some embodiments, BWP info is not included. In embodiments such as these, the BWP of the random access configuration for which additional ROs are (de-)activated is the initial UL BWP if UE 1002 is in and RRC IDLE or RRC_INACTIVE state. In some embodiments, BWP info is not included. In embodiments such as these, the BWP of the random access configuration for which additional ROs are (de-)activated is the redcap specific initial UL BWP (if configured) if UE 1002 is a redcap UE and is in an RRC IDLE or RRC_INACTIVE state and the DCI is received in a redcap specific initial DL BWP. In some embodiments, BWP info is not included. In embodiments such as these, the BWP of the random access configuration for which additional ROs are (de-)activated is the initial UL BWP (if a redcap specific initial UL BWP is not configured) and if UE 1002 is redcap UE and is in an RRC IDLE or RRC_INACTIVE state and the LPWUS is received in a redcap specific initial DL BWP. In embodiments such as these, if the UE 1002 is in an RRC_CONNECTED state, additional ROs are (de-)activated in the random access configuration(s) of the active UL BWP at the time the DCI indicating (de-)activation of additional ROs is received or the active UL BWP upon reception of the DCI indicating (de-)activation of additional ROs. In embodiments such as these, if the UE 1002 is in an RRC_IDLE or RRC_INACTIVE state (i.e. UE 1002 is not in an RRC_CONNECTED state), additional ROs are (de-)activated in the random access configuration(s) of the initial UL BWP upon reception of the DCI indicating (de-)activation of additional ROs. In embodiments such as these, if the UE 1002 is in an RRC_IDLE or RRC_INACTIVE stater (i.e., the UE is not in RRC_CONNECTED state), additional ROs are (de-)activated in the random access configuration(s) of the initial UL BWP and redcap specific initial UL BWP (if configured) upon reception of the DCI indicating (de-)activation of additional ROs. In embodiments such as these, additional ROs are (de-)activated in the random access configuration(s) of the redcap specific initial UL BWP (if configured) if the UE 10002 is a redcap UE and is in an RRC IDLE or RRC_INACTIVE state and the DCI indicating (de-)activation of additional ROs is received in a redcap specific initial DL BWP. In embodiments such as these, additional ROs are (de-)activated in the random access configuration(s) of the initial UL BWP (if a redcap specific initial UL BWP is not configured) and if the UE 1002 is a redcap UE and is in an RRC IDLE or RRC_INACTIVE state and DCI indicating (de-)activation of additional ROs is received in the redcap specific initial DL BWP.

In some embodiments, if there are multiple random access configurations of the indicated RA type in the indicated BWP of the indicated carrier, a random access configuration index may be included in the LPWUS to indicate the random access configuration amongst these random access configurations for which additional ROs are (de-)activated. The random access configuration index associated with a random access configuration can be explicitly signaled in the random access configuration. Alternately, random access configurations can be sequentially indexed in the order in which they are listed in a list of random access configurations.

In some embodiments, if there are multiple random access configurations of the indicated RA type in the indicated BWP of the indicated carrier, additional ROs can be configured only for one random access configuration and additional ROs of this random access configuration are (de-)activated upon receiving the LPWUS (de-)activating additional ROs.

In some embodiments, if there are multiple random access configurations of the indicated RA type in the indicated BWP of the indicated carrier, additional ROs can be configured only for the random access configuration not associated with any feature and additional ROs of this random access configuration are (de-)activated upon receiving the LPWUS (de-)activating additional ROs.

In some embodiments, if there are multiple random access configurations of the indicated RA type in the indicated BWP of the indicated carrier, additional ROs are considered (de-)activated for all random access configurations with additional ROs upon receiving the LPWUS (de-)activating additional ROs.

In some embodiments, the additional ROs are (de-)activated from the end of an SI modification period or defaultPagingCycle or RACH adaptation cycle/interval in which the LPWUS (de-)activating additional ROs is received by UE 1002.

Although FIG. 10 illustrates one example procedure for activating additional ROs 1000, various changes may be made to FIG. 10. For example, while shown as a series of operations, various operations in FIG. 10 could overlap, occur in parallel, occur in a different order, occur any number of times, be omitted, or replaced by other operations.

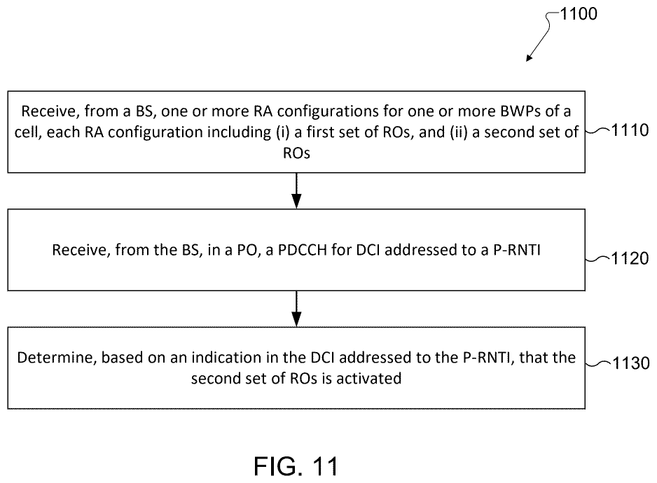

FIG. 11 illustrates an example method for adapting RACH occasions 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for adapting RACH occasions could be used without departing from the scope of this disclosure.

In the example of FIG. 11, method 1100 begins at step 1110. At step 1110, a UE (such as UE 116 of FIG. 1) receives, from a BS (such as BS 102 of FIG. 1), one or more RA configurations for one or more BWPs of a cell. Each RA configuration includes (i) a first set of ROs, and (ii) a second set of ROs.

At step 1120, the UE receives, from the BS, in a PO, a PDCCH for DCI addressed to a P-RNTI.

At step 1130, the UE determines, based on an indication in the DCI addressed to the P-RNTI, that the second set of ROs is activated.

In some embodiments, to receive the indication that the second set of ROs is activated, the UE may determine an RRC state of the UE. In response to a determination that the RRC state of the UE is RRC_IDLE, the UE may monitor the PDCCH for the DCI addressed to the P-RNTI in POs of the UE. Tn response to a determination that the RRC state of the UE is RRC_INACTIVE, the UE may determining whether an SDT procedure is ongoing in the RRC_INACTIVE state, and in response to a determination that an SDT procedure is not ongoing in the RRC_INACTIVE state, the UE may monitor the PDCCH for the DCI addressed to the P-RNTI in the POs of the UE. In response to a determination that the RRC state of the UE is RRC_CONNECTED, the UE may monitor the PDCCH for the DCI addressed to the P-RNTI in any PO at least once in a modification period.

In some embodiments, to receive the indication that the second set of ROs is activated, in response to a first determination that (i) the UE is an in RRC_INACTIVE state and (ii) a small data transmission (SDT) procedure is ongoing, the UE may determine a second determination whether (i) a timer T319a is not running, and (ii) ongoing SDT is based on configured grants and (iii) an extended configured grant (CG)-SDT periodicity is configured. In response to the second determination being affirmative, the UE may monitor the PDCCH for the DCI addressed to the P-RNTI in POs of the UE. Tn response to the second determination being negative, the UE may determine a third determination whether an initial downlink BWP on which the SDT procedure is ongoing is associated with a CD-SSB, and in response to the third determination being affirmative, the UE may monitor the PDCCH for the DCI addressed to the P-RNTI in any PO at least once per modification period.

In some embodiments, to receive the indication that the second set of ROs is activated, in response to a determination that (i) the UE is an in RRC_INACTIVE state and (ii) a small data transmission (SDT) procedure is not ongoing, the UE may monitor the PDCCH for the DCI addressed to the P-RNTI in the POs of the UE.

In some embodiments, the second set of ROs may be received in an RA configuration of an initial uplink BWP. In embodiments such as these, the UE may determine that the second set of ROs is activated based on the indication in the DCI addressed to the P-RNTI being received in an initial downlink BWP.

In some embodiments, the second set of ROs may be received in an RA configuration of an active uplink BWP. In embodiments, such as these, the UE may determine that the second set of ROs is activated based on the indication in the DCI addressed to the P-RNTI being received in an active downlink BWP.

In some embodiments, each RA configuration may separately signal parameters prach-ConfigurationIndex, msg1-FrequencyStart, msg1-FDM and number of SSBs per RO for the first set of ROs and the second set of ROs.

In some embodiments, the DCI addressed to the P-RNTI may include at least one of RA type, BWP info, and carrier type of random access configuration for which the second set of ROs are activated.

In some embodiments, the UE may receive, from the BS, information indicating whether the UE selects the first set of ROs or the second set of ROs for random access preamble transmission.

Although FIG. 11 illustrates one example method for adapting RACH occasions 1100, various changes may be made to FIG. 11. For example, while shown as a series of steps, various steps in FIG. 11 could overlap, occur in parallel, occur in a different order, occur any number of times, be omitted, or replaced by other steps.

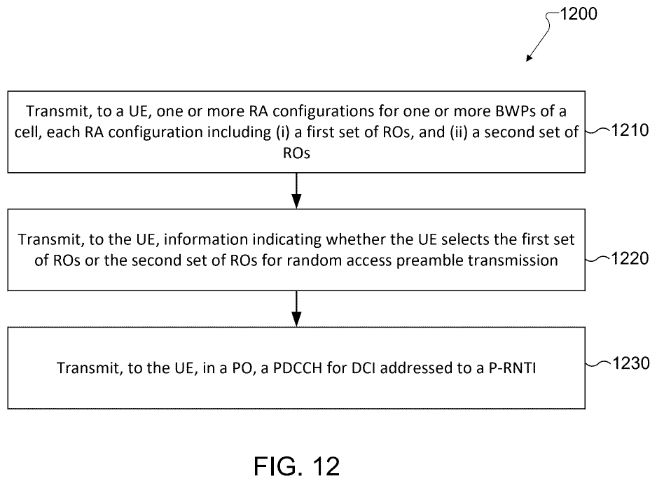

FIG. 12 illustrates another example method for adapting RACH occasions 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for adapting RACH occasions could be used without departing from the scope of this disclosure.

In the example of FIG. 12, method 1200 begins at step 1210. At step 1210, a BS (such as BS 102 of FIG. 1) transmits, to a UE (such as UE 116 of FIG. 1), one or more RA configurations for one or more BWPs of a cell. Each RA configuration includes (i) a first set of ROs, and (ii) a second set of ROs.

At step 1220, the BS transmits, to the UE, information indicating whether the UE selects the first set of ROs or the second set of ROs for random access preamble transmission.

At step 1230, the BS transmits, to the UE, in a PO, a PDCCH for DCI addressed to a P-RNTI. In some embodiments, the DCI addressed to the P-RNTI may include at least one of RA type, BWP info, and carrier type of random access configuration for which the second set of ROS are activated.

In some embodiments, the BS may transmit the second set of ROs in an RA configuration of an initial uplink BWP.

In some embodiments, the BS may transmit the indication in the DCI addressed to the P-RNTI in an initial downlink BWP.

Although FIG. 12 illustrates one example method for adapting RACH occasions 1100, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS), one or more random access (RA) configurations for one or more bandwidth parts (BWPs) of a cell, each RA configuration including (i) a first set of random access occasions (ROs) and (ii) a second set of ROs, and associated with at least a feature or a feature combination; and
receive, from the BS, in a paging occasion (PO), a physical downlink control channel (PDCCH) for downlink control information (DCI) addressed to a paging radio network temporary identifier (P-RNTI); and
a processor operably coupled to the transceiver, the processor configured to determine, based on an indication in the DCI addressed to the P-RNTI, that the second set of ROs is activated.

2. The UE of claim 1, wherein to receive the indication that the second set of ROs is activated, the processor is further configured to:
determine a radio resource control (RRC) state of the UE;
in response to a determination that the RRC state of the UE is RRC_IDLE, monitor the PDCCH for the DCI addressed to the P-RNTI in POs of the UE;
in response to a determination that the RRC state of the UE is RRC_INACTIVE:
determine whether a small data transmission (SDT) procedure is ongoing in the RRC_INACTIVE state; and
in response to a determination that an SDT procedure is not ongoing in the RRC_INACTIVE state, monitor the PDCCH for the DCI addressed to the P-RNTI in the POs of the UE; and
in response to a determination that the RRC state of the UE is RRC_CONNECTED, monitor the PDCCH for the DCI addressed to the P-RNTI in any PO at least once in a modification period.

3. The UE of claim 1, wherein to receive the indication that the second set of ROs is activated, the processor is further configured to:
in response to a first determination that (i) the UE is an in RRC_INACTIVE state and (ii) a small data transmission (SDT) procedure is ongoing, determine a second determination whether (i) a timer T319a is not running, and (ii) ongoing SDT is based on configured grants and (iii) an extended configured grant (CG)-SDT periodicity is configured;
in response to the second determination being affirmative, monitor the PDCCH for the DCI addressed to the P-RNTI in POs of the UE; and
in response to the second determination being negative:
determine a third determination whether an initial downlink BWP on which the SDT procedure is ongoing is associated with a CD-SSB; and
in response to the third determination being affirmative, monitor the PDCCH for the DCI addressed to the P-RNTI in any PO at least once per modification period.

4. The UE of claim 1, wherein to receive the indication that the second set of ROs is activated, the processor is further configured to, in response to a determination that (i) the UE is an in RRC_INACTIVE state and (ii) a small data transmission (SDT) procedure is not ongoing, monitor the PDCCH for the DCI addressed to the P-RNTI in the POs of the UE.

5. The UE of claim 1, wherein:
the second set of ROs is received in an RA configuration of an initial uplink BWP; and
the processor is further configured to determine that the second set of ROs is activated based on the indication in the DCI addressed to the P-RNTI being received in an initial downlink BWP.

6. The UE of claim 1, wherein:
the second set of ROs is received in an RA configuration of an active uplink BWP; and
the processor is further configured to determine that the second set of ROs is activated based on the indication in the DCI addressed to the P-RNTI being received in an active downlink BWP.

7. The UE of claim 1, wherein each RA configuration separately signals parameters prach-ConfigurationIndex, msg1-FrequencyStart, msg1-FDM and number of SSBs per RO for the first set of ROs and the second set of ROs.

8. The UE of claim 1, wherein the DCI addressed to the P-RNTI includes at least one of RA type, BWP info, and carrier type of random access configuration for which the second set of ROS are activated.

9. The UE of claim 1, wherein the transceiver is further configured to receive, from the BS, information indicating whether the UE selects the first set of ROs or the second set of ROs for random access preamble transmission.

10. A base station (BS) comprising:
a processor; and
a transceiver operably coupled to the processor, the transceiver configured to:
transmit, to a user equipment (UE), one or more random access (RA) configurations for one or more bandwidth parts (BWPs) of a cell, each RA configuration including (i) a first set of random access occasions (ROs) and (ii) a second set of ROs, and associated with at least a feature or a feature combination;
transmit, to the UE, information indicating whether the UE selects the first set of ROs or the second set of ROs for random access preamble transmission; and
transmit, to the UE, in a paging occasion (PO), a physical downlink control channel (PDCCH) for downlink control information (DCI) addressed to a paging radio network temporary identifier (P-RNTI),
wherein the DCI addressed to the P-RNTI includes at least one of RA type, BWP info, and carrier type of random access configuration for which the second set of ROS are activated.

11. The BS of claim 10, wherein:
the second set of ROs is transmitted in an RA configuration of an initial uplink BWP; and
the indication in the DCI addressed to the P-RNTI is transmitted in an initial downlink BWP.

12. A method of operating a user equipment (UE), the method comprising:
receiving, from a base station (BS), one or more random access (RA) configurations for one or more bandwidth parts (BWPs) of a cell, each RA configuration including (i) a first set of random access occasions (ROs), and (ii) a second set of ROs, and associated with at least a feature or a feature combination;
receiving, from the BS, in a paging occasion (PO), a physical downlink control channel (PDCCH) for downlink control information (DCI) addressed to a paging radio network temporary identifier (P-RNTI); and
determining, based on an indication in the DCI addressed to the P-RNTI, that the second set of ROs is activated.

13. The method of claim 12, wherein to receive the indication that the second set of ROs is activated, the method further comprises:
determining a radio resource control (RRC) state of the UE;
in response to a determination that the RRC state of the UE is RRC_IDLE, monitoring the PDCCH for the DCI addressed to the P-RNTI in POs of the UE;
in response to a determination that the RRC state of the UE is RRC_INACTIVE:
determining whether a small data transmission (SDT) procedure is ongoing in the RRC_INACTIVE state; and
in response to a determination that an SDT procedure is not ongoing in the RRC_INACTIVE state, monitoring the PDCCH for the DCI addressed to the P-RNTI in the POs of the UE; and
in response to a determination that the RRC state of the UE is RRC_CONNECTED, monitoring the PDCCH for the DCI addressed to the P-RNTI in any PO at least once in a modification period.

14. The method of claim 12, wherein to receive the indication that the second set of ROs is activated, the method further comprises:
in response to a first determination that (i) the UE is an in RRC_INACTIVE state and (ii) a small data transmission (SDT) procedure is ongoing, determining a second determination whether (i) a timer T319a is not running, and (ii) ongoing SDT is based on configured grants and (iii) an extended configured grant (CG)-SDT periodicity is configured;
in response to the second determination being affirmative, monitoring the PDCCH for the DCI addressed to the P-RNTI in POs of the UE; and
in response to the second determination being negative:
determining a third determination whether an initial downlink BWP on which the SDT procedure is ongoing is associated with a CD-SSB; and
in response to the third determination being affirmative, monitoring the PDCCH for the DCI addressed to the P-RNTI in any PO at least once per modification period.

15. The method of claim 12, wherein to receive the indication that the second set of ROs is activated, the method further comprises, in response to a determination that (i) the UE is an in RRC_INACTIVE state and (ii) a small data transmission (SDT) procedure is not ongoing, monitoring the PDCCH for the DCI addressed to the P-RNTI in the POs of the UE.

16. The method of claim 12, wherein:
the second set of ROs is received in an RA configuration of an initial uplink BWP; and
the method further comprises determining that the second set of ROs is activated based on the indication in the DCI addressed to the P-RNTI being received in an initial downlink BWP.

17. The method of claim 12, wherein:
the second set of ROs is received in an RA configuration of an active uplink BWP; and
the method further comprises determining that the second set of ROs is activated based on the indication in the DCI addressed to the P-RNTI being received in an active downlink BWP.

18. The method of claim 12, wherein each RA configuration separately signals parameters prach-ConfigurationIndex, msg1-FrequencyStart, msg1-FDM and number of SSBs per RO for the first set of ROs and the second set of ROs.

19. The method of claim 12, wherein the DCI addressed to the P-RNTI includes at least one of RA type, BWP info, and carrier type of random access configuration for which the second set of ROs are activated.

20. The method of claim 12, further comprising receiving, from the BS, information indicating whether the UE selects the first set of ROs or the second set of ROs for random access preamble transmission.
